(19) United States
(12) Patent Application Publication
(10) Pub. No.: US 2014/0178125 A1
(43) Pub. Date: Jun. 26, 2014

(54) STAMPED CLEVIS

(71) Applicants: Gary Crewson, Hamburg, NY (US); Bernard Malka, Marietta, GA (US)

(72) Inventors: Gary Crewson, Hamburg, NY (US); Bernard Malka, Marietta, GA (US)

(21) Appl. No.: 13/723,768

(22) Filed: Dec. 21, 2012

(51) Int. Cl. B21D 35/00; B21D 53/00; F16B 37/00

(52) U.S. Cl. CPC B21D 35/001; F16B 37/00; B21D 53/00
USPC 403/299; 72/325; 72/47

(57) ABSTRACT

A clevis including a bridge portion, a cylindrically shaped neck formed from the bridge, and folded side walls extending from the bridge portion in a first direction. One side wall includes a first hole and a first surface parallel to a longitudinal axis. The other side wall includes a second hole and a second surface facing the first surface. The clevis includes a threaded opening, in the bridge and neck, aligned with the axis and a space formed by the bridge and side walls. The neck is formed from the bridge portion in the first direction or is formed from the bridge portion in a third direction, opposite the first direction. The material includes one only single piece of low carbon steel. The first and second surfaces are parallel to the longitudinal axis.

### TECHNICAL FIELD

The present disclosure relates to a clevis for an air brake application stamped from low carbon steel, in particular, a clevis with a threaded portion having sufficient length and thickness to increase the durability of the clevis.

### BACKGROUND

It is known to fabricate a clevis for an air brake application by casting. However, casting is a relatively slow and expensive operation. For example, a mold must be formed, the actual casting and cooling requires a relatively long time span, and finishing operations are needed to remove imperfections inherent in the casting process. In addition, the casting process inherently produces unusable product, further increasing cost and time. Further, casting operations have undesirable environmental impacts associated with high energy usage, air and water emissions, and disposal of hazardous materials used in the molding and casting operations. Finally, casting constraints limit shapes, for example, more complicated internal configurations, that can be produced by casting operations.

In general, clevises for air brake operations include a threaded segment for connecting to an air brake system. When the air brake system is in use, tremendous stresses are applied to the threaded segment. In order to ensure adequate longevity for the clevis, it is known to maximize the length and thickness of the threaded segment.

SUMMARY

According to aspects illustrated herein, there is provided a clevis for an air brake assembly, including: a longitudinal axis; a bridge portion; a cylindrically shaped neck formed from the bridge portion, and first and second folded side walls. The first folded side wall extends from the bridge portion in a first direction parallel to the longitudinal axis and includes a first surface facing in a second direction orthogonal to the longitudinal axis and a first hole passing through material forming the clevis and wholly surrounded by the material. The second folded side wall extends from the bridge portion in the first direction and includes a second surface facing the first surface and a second hole passing through the material and wholly surrounded by the material. The clevis includes: a threaded opening passing through the bridge portion and the neck, wholly surrounded by the material forming the clevis, and aligned with the longitudinal axis; and a space formed by the bridge and the first and second side walls. The cylindrically shaped neck is formed from the bridge portion in the first direction or is formed from the bridge portion in a third direction, opposite the first direction. The material includes one only single piece of low carbon steel. The first and second surfaces are parallel to the longitudinal axis and are aligned in the second direction. The longitudinal axis passes through the threaded opening and the space.

According to aspects illustrated herein, there is provided a method of stamping a clevis for an air brake assembly, including stamping a sheet of steel to form a planar blank including: a first longitudinal axis passing through first and second longitudinal ends; first and second oppositely facing planar surfaces; a central portion with a uniform width orthogonal to the first longitudinal axis; a first end portion extending from the central portion along the first longitudinal axis in a first direction and tapering toward the first longitudinal end; and a second end portion extending from the central portion along the first longitudinal axis in a second direction, opposite the first direction, and tapering toward the second longitudinal end. The method pierces the blank to form a first hole between a center point of the first longitudinal axis and the first longitudinal end and connecting the first and second surfaces and a second hole between the center point of the first longitudinal axis and the second longitudinal end and connecting the first and second surfaces. The method forms the blank to form a ring-shaped neck including a third hole and extending from the central portion and the second planar surface in a third direction parallel to a second longitudinal axis passing through the third hole. The method bends a first portion of the blank, including the first longitudinal end, along a first line orthogonal to the first longitudinal axis, passing through the central portion, and between the first hole and the third hole such that the first portion of the blank is parallel to the second longitudinal axis and extends from the central portion in a fourth direction, opposite the third direction. The method: bends a second portion of the blank, including the second longitudinal end, along a second line orthogonal to the first longitudinal axis, passing through the central portion, and between the second hole and the third hole such that the second portion of the blank is parallel to the second longitudinal axis and respective segments of the first surface included in the first and second portions of the blank face each other; and threads an inner circumferential surface of the third hole.

According to aspects illustrated herein, there is provided a method of stamping a clevis for an air brake assembly, including stamping a sheet of steel to form a planar blank including: a first longitudinal axis passing through first and second longitudinal ends; first and second oppositely facing planar surfaces; a central portion with a uniform width orthogonal to the first longitudinal axis; a first end portion extending from the central portion along the first longitudinal axis in a first direction and tapering toward the first longitudinal end; and a second end portion extending from the central portion along the first longitudinal axis in a second direction, opposite the first direction, and tapering toward the second longitudinal end. The method pierces the blank to form a first hole between a center point of the first longitudinal axis and the first longitudinal end and connecting the first and second surfaces and a second hole between the center point of the first longitudinal axis and the second longitudinal end and connecting the first and second surfaces. The method forms the blank to form a ring-shaped neck including a third hole and extending from the central portion and the first planar surface in a third direction parallel to a second longitudinal axis passing through the third hole. The method bends a first portion of the blank, including the first longitudinal end, along a first line orthogonal to the first longitudinal axis, passing through the central portion, and between the first hole and the third hole such that the first portion of the blank is parallel to the second longitudinal axis and extends from the central portion in the third direction. The method bends a second portion of the blank, including the second longitudinal end, along a second line orthogonal to the first longitudinal axis, passing through the central portion, and between the second hole and the third hole such that the second portion of the blank is parallel to the second longitudinal axis and respective segments of the first surface included in the first and second portions of the blank face each other and threads an inner circumferential surface of the third hole.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is an end view of a stamped clevis;

FIG. 2 is a side view of the stamped clevis of FIG. 1;

FIG. 3 is a cross-sectional end view substantially along line 3-3 in FIG. 1;

FIG. 4 is a cross-sectional view of a stamped clevis;

FIG. 5 is a plan view of a blank formed from a piece of steel;

FIG. 6 is a plan view of the blank of FIG. 5 with pierced holes; and,

FIG. 7 is a side view of the blank of FIG. 5 showing a formed neck.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

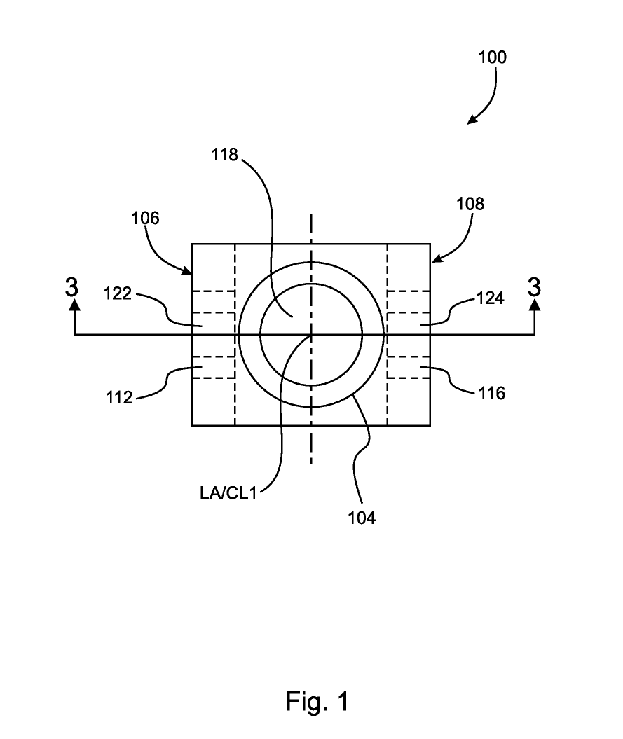

FIG. 1 is an end view of stamped clevis 100.

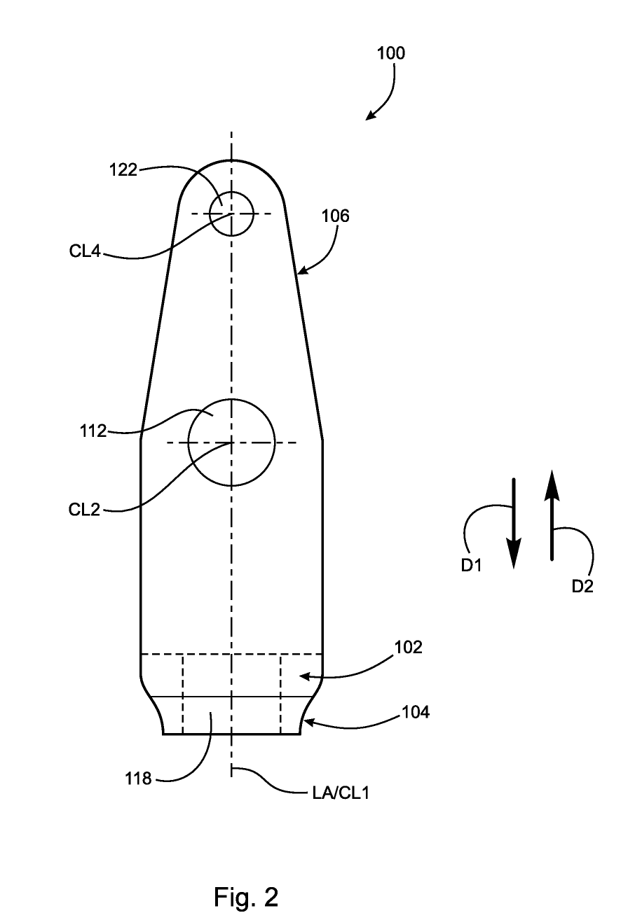

FIG. 2 is a side view of stamped clevis 100 of FIG. 1.

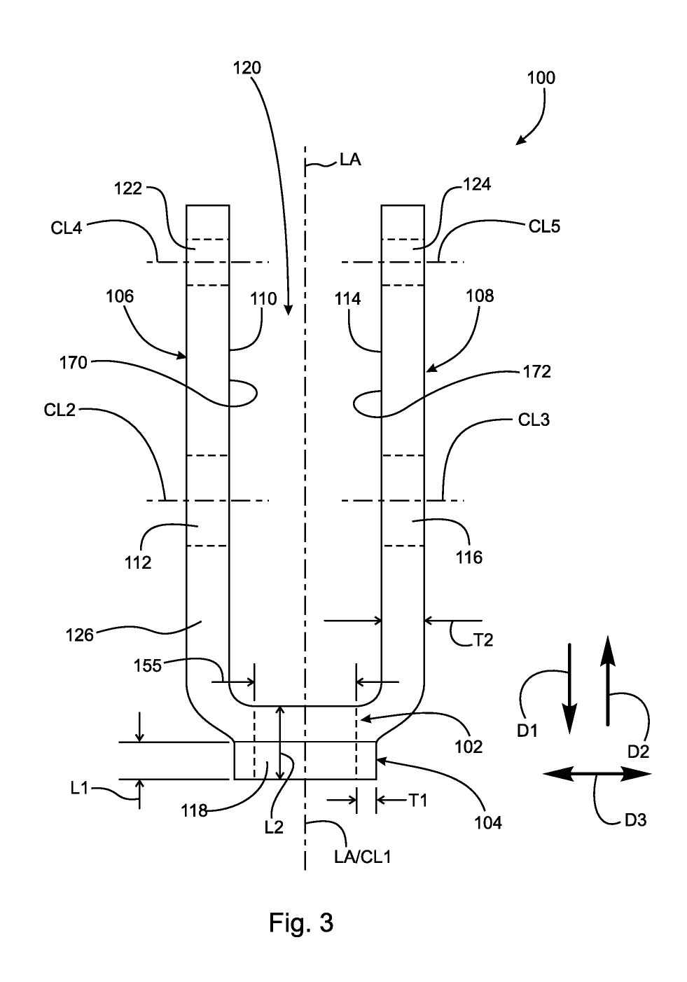

FIG. 3 is a cross-sectional end view substantially along line 3-3 in FIG. 1. The following should be viewed in light of FIGS. 1 through 3. Stamped clevis 100 for an air brake assembly includes bridge portion 102, cylindrically shaped neck 104 formed from the bridge portion, folded side wall 106, and folded side wall 108. The neck extends from the bridge portion in a direction D1 parallel to longitudinal axis LA. By “formed from” we mean any means known in the art for producing a first portion of a component by operating on a second portion of the component, the two portions being integral to a single piece of material. In an example embodiment such forming includes extruding the first portion from the second portion. Side wall 106 extends from the bridge portion in direction D2, opposite D1 and includes surface 110 facing in direction D3 orthogonal to axis LA, and hole 112 passing through material forming the clevis. Clevis 100 is formed from a single piece of low carbon steel as further described below. The steel forming the clevis is folded adjacent to the bridge portion to form folded walls 106 and 108. In a preferred embodiment, the low carbon steel has a carbon content less than 0.15%. In an example embodiment, the low carbon steel has a carbon content of at least 0.15%. Side wall 108 extends from the bridge portion in direction D2 and includes surface 114 facing in direction D3 and hole 116 passing through the material. Holes 112 and 116 are wholly surrounded by the material. Threaded opening 118 passes through the bridge portion and the neck and is wholly surrounded by the material forming the clevis. Axis LA passes through opening 118 and is centered in opening 118, for example, center line CL1 for opening 118 is co-linear with LA.

The clevis includes space 120 formed by the bridge and side walls 106 and 108. Side walls 106 and 108 are symmetrical with respect to axis LA. For example, surfaces 110 and 114 are equidistant from LA. Holes 112 and 116 are aligned in a direction D3, orthogonal to axis LA. For example, centerlines CL2 and CL3 are aligned in direction D3.

In an example embodiment, the clevis includes holes 122 and 124 in side walls 106 and 108, respectively. Holes 122 and 124 pass through the material forming the side walls and are wholly surrounded by the material forming the side walls. Holes 122 and 124 are aligned in a direction D3. For example, centerlines CL4 and CL5 are aligned in direction D3. In an example embodiment, holes 112 and 122 are aligned in direction D2 and holes 116 and 124 are aligned in direction D2.

As noted above, clevis 100 is formed of a single piece of low carbon steel. In an example embodiment, the clevis is coated with corrosion-resistant metallic coating 126. In an example embodiment, the coating is zinc plating with blue trivalent chrome passivation.

As noted above, durability of a clevis for an air brake application is highly dependent on the length of the threaded portion of the clevis; specifically, too little length results in undesirably early failure of the threaded portion and the clevis. As noted below, the neck of clevis 100 is formed by forming a central portion (including the bridge portion) during stamping operations to form the clevis. Advantageously, the novel forming steps of the present disclosure enable a desirable length L1 and a desirably thickness T1 of the neck. For example, thickness T1 must be large enough to withstand the stresses associated with use of the clevis in an air brake application. In an example embodiment, thickness T1 is about ¾ the thickness of T2 of the side walls. In an example embodiment, T2 is approximately 8 mm and T1 is approximately 6 mm.

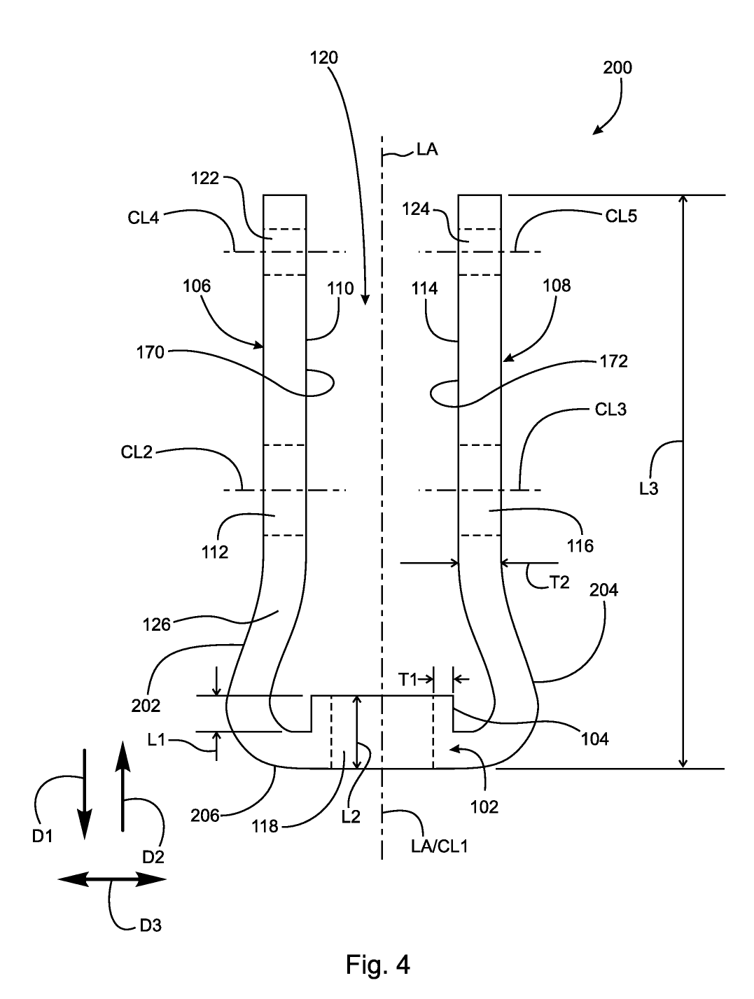

FIG. 4 is a cross-sectional view of stamped clevis 200. The description of FIGS. 1 through 3 for clevis 100 is applicable to clevis 200 except as noted. For clevis 200, neck portion 104 extends from bridge portion 102 into space 120 in direction D2, rather than in direction D1. To accommodate the neck portion, sections 202 and 204 of side walls 106 and 108, respectively, are bowed outward (away from axis LA). Advantageously, positioning the neck portion between the side walls reduces overall length L3 of clevis 200, making clevis 200 more compact and reducing the axial space needed for clevis 200 in a particular application or installation. Further, surface 206, against which a lock nut (not shown) is tightened when clevis 200 is in use, requires nominal machining to provide a planar surface for the lock nut. In addition, surface 206 forms the contact area for a “jam nut” and is considerably greater than the contact area for clevis 100, which is formed by the distal end of portion 104. The increase in contact area advantageously provides better load distribution to the clevis.

It would be very difficult and expensive, if possible at all, to produce the shape of clevis 200 by casting, due, for example, to neck portion 104 extending in direction D2 and the curvature of sections 202 and 204.

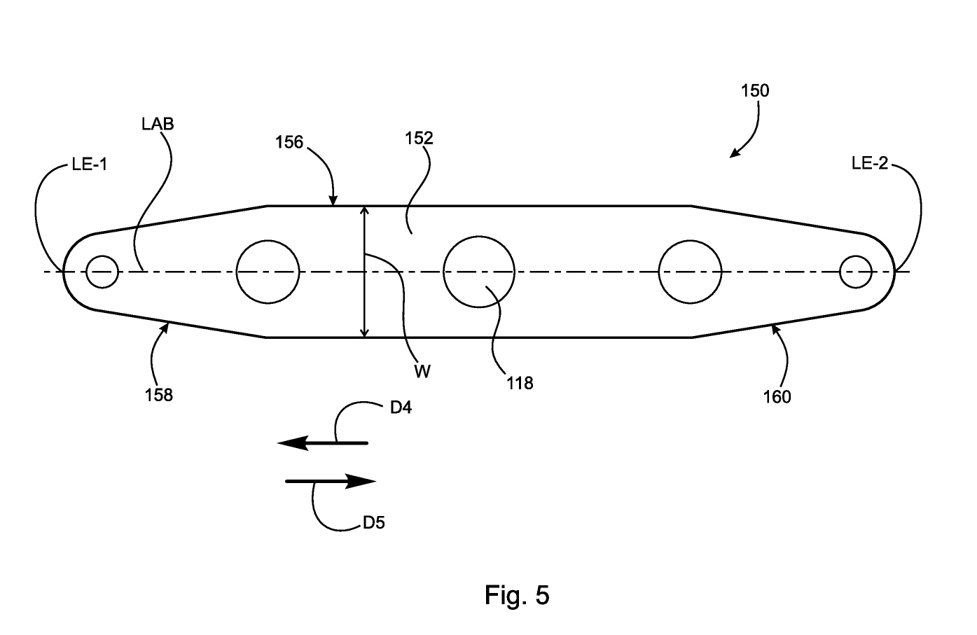

FIG. 5 is a plan view of a blank formed from a piece of steel. The discussion that follows is directed to a method of forming clevis 100 by stamping. A first step forms planar blank 150 by stamping a sheet of low carbon steel. The blank includes longitudinal axis LAB passing through longitudinal ends LE-1 and LE-2 and surface 152. Surface 154 is not visible in FIG. 4 and faces oppositely from surface 152. The blank includes central portion 156 with width W along surface 152 orthogonal to LAB. The blank includes end portions 158 and 160. 158 extends from the central portion along the longitudinal axis in direction D4 and tapers toward longitudinal end LE-1. End portion 160 extends from the central portion along the longitudinal axis in direction D5, opposite D4, and tapers toward longitudinal end LE-2.

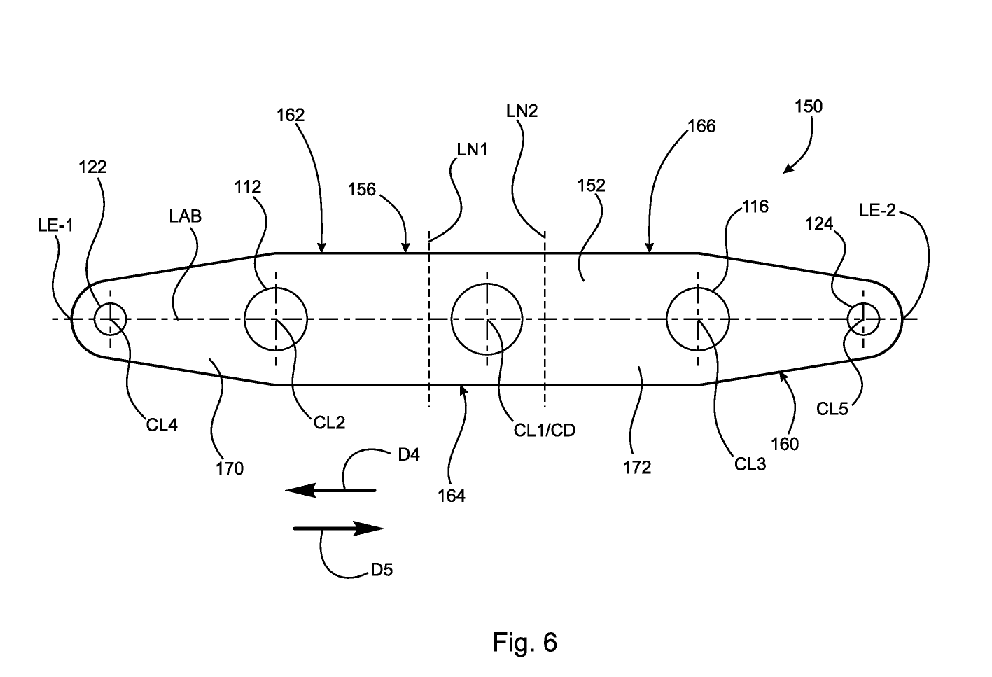

FIG. 6 is a plan view of the blank of FIG. 5 with pierced holes. A next step pierces the blank to form holes 112 and 116. Hole 112 is between center point CP of the longitudinal axis and LE-1, and connects surfaces 152 and 154. Hole 116 is between center point CP and LE-2, and connects surfaces 152 and 154.

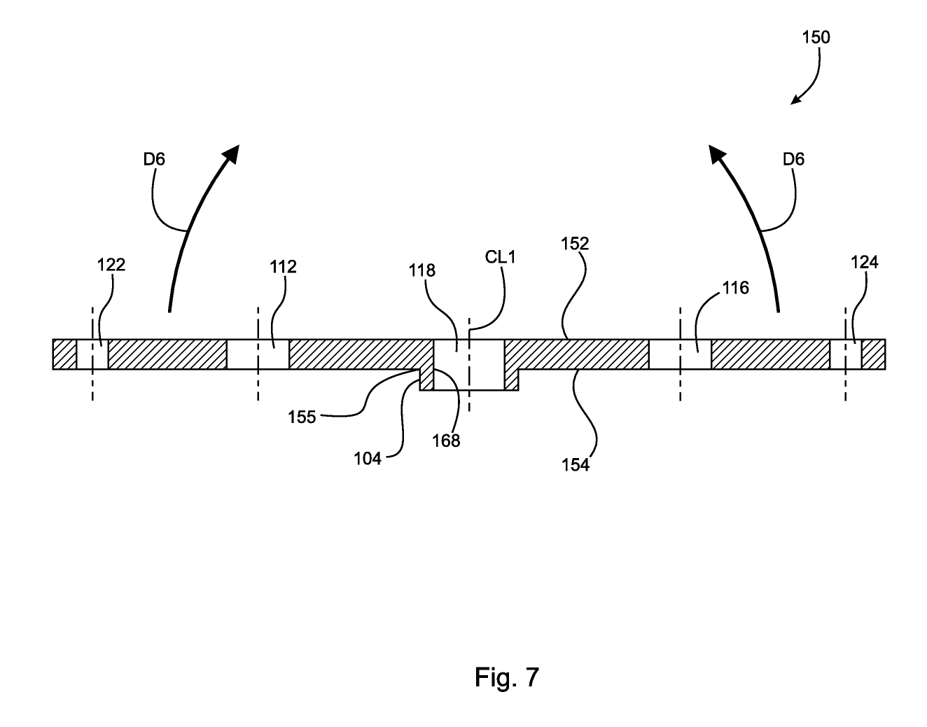

FIG. 7 is a side view of the blank of FIG. 5 showing a formed neck. A further step forms the blank at center point CP to form ring-shaped neck 104 extending from surface 154 and hole 118 passing through the neck. In an example embodiment, a pilot hole is punched at center point CP prior to forming neck 104. Pre-punching hole 118 results in maximizing extrusion height L1 without unevenness in the formation, for example, thickness T1 is consistent throughout length L1. Pre-punching hole 118 also results in consistent perpendicularity of hole 118 with respect to holes 112, 116, 122, and 124. Moreover, pre-punching hole 118 assists with and/or guides the extrusion punch thereby providing more consistent results on the formed portion and increasing the length of the extrusion area. Furthermore, a slight radius may be provided on the entry portion of the extrusion punch which assists with the release of clevis 100 after the extrusion operation. In an example embodiment, neck portion 104 is formed in the opposite direction to extend from surface 152, for example, as shown for clevis 200. Corner 155 in FIG. 7 is shown as square; however, it should be understood that corner 155 can be rounded, for example, formed with a radius.

The following should be viewed in light of FIGS. 6 and 7. A still further step bends the blank, generally in direction D6 in FIG. 7, to form the side walls. The method bends portion 162 of the blank, including end LE-1, along line LN1 in FIG. 6, orthogonal to LAB, passing through the central portion, and between holes 112 and 118 such that portion 162 is orthogonal to segment 164 of the central portion including hole 118. The step bends portion 166 of the blank, including end LE-2, along line LN2 in FIG. 6 orthogonal to LAB, passing through the central portion, and between holes 116 and 118 such that portion 166 is orthogonal to segment 164. Thus, the step forms side walls 106 and 108. Segment 164 includes the bridge portion and the neck. The step also threads inner circumferential surface 168 of hole 118. In an example embodiment, portions 202 and 204 are bowed to form the configuration shown in FIG. 4 for clevis 200.

Bending the blank includes forming axis LA passing through and centered in hole 118, and positioning segments 170 and 172 of surface 152 included in portions 162, and 166, respectively, to be equidistant from the second axis. That is, segments 170 and 172 form surfaces 174 and 176 at least partially defining space 120. Bending the blanks includes positioning segments 170 and 172 parallel to LA. Bending the blanks includes positioning segments 170 and 172 parallel to each other.

The method includes enlarging holes 112 and 116 such that holes 112 and 116 are aligned in a direction D3, for example, CL2 and CL3 are co-linear. Enlarging holes includes removing respective material forming the holes by any means known in the art, including but not limited to: reaming; fine blanking; shot peening; electric based machining, such as electric discharge machining; and chemical etching.

In an example embodiment, the method pierces the blank to form holes 122 and 124. Hole 122 is between hole 112 and LE-1 and connects surfaces 152 and 154. Hole 124 is between hole 116 and LE-2 and connects surfaces 152 and 154. The method aligns holes 112 and 122 in direction D2 and holes 116 and 124 in direction D2. The method includes enlarging holes 122 and 124 such that holes 122 and 124 are aligned in a direction D3, for example, CL4 and CL5 are co-linear.

In an example embodiment, the method applies a corrosion-resistant metallic coating to the clevis.

Clevises 100 and 200 advantageously overcomes the problems noted above, associated with casting of a clevis. Stamping operations are much quicker and less expensive than casting operations. For example, fabricating cutting dies is relatively quick and inexpensive in comparison to the molding process needed for casting operations. The actual stamping operations are very quick. For some steps, such as cutting the blank and piercing holes, multiple units can operated at once with a single press. Thus, the time associated with stamping is less than that needed for pouring/casting and cooling.

Further, finishing operations are very minimal for stamping operations in comparison to casting operations, for example, only nominal de-burring may be required. Stamping operations are much more controllable, predictable, and repeatable, resulting in a much lower rate of unusable product than casting operations. Finally, stamping operations have fewer environmental impacts. The nominal air and water emissions for stamping operations do not require the regulatory, control, and waste disposal activities required for casting operations. The energy needed to operate presses is less than the energy needed for casting. There are no hazardous or restricted waste products produced by stamping operations, as can be the case for casting processes. Any portions of the waste steel produced by the stamping operations can be readily used in other stamping operations or recycled.

As well as providing the advantages noted above, stamped clevises 100 and 200 are robust. For example, as noted above, it is desirable to maximize a length and thickness of a threaded segment for a clevis. The forming operation noted above advantageously results in neck 104 extending beyond portion 102 by length L1, increasing length L2 of threaded hole 118. Further, a majority of thickness T2 of the blank and the side walls is preserved in the neck. For example, as noted above, T1 can be about ¾ of T2. The positive contact between the mating surfaces of the neck of the clevis and the locking nut can be improved by including a machining operation after the hole extrusion operation. Such machining operation may also be used to maintain an even formed height on the clevis.

It has been found that to perform the desired present invention extrusion processes, the raw material must flow very easily during the operation. To achieve the necessary flow characteristics, the carbon percentage must be maintained at a low carbon level which cannot exceed 0.15%. Components fabricated from material comprising greater than 0.15% carbon resulted in crack development on the top area of the formed portion of the present invention clevis.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A clevis for an air brake assembly, comprising:
a longitudinal axis;
a bridge portion;
a cylindrically shaped neck formed from the bridge portion;
a first folded side wall extending from the bridge portion in a first direction parallel to the longitudinal axis and comprising:
a first surface facing in a second direction orthogonal to the longitudinal axis; and,
a first hole passing through material forming the clevis and wholly surrounded by the material;
a second folded side wall extending from the bridge portion in the first direction and comprising:
a second surface facing the first surface; and,
a second hole passing through the material and wholly surrounded by the material;
a threaded opening passing through the bridge portion and the neck, wholly surrounded by the material forming the clevis, and aligned with the longitudinal axis; and,
a space formed by the bridge and the first and second side walls, wherein:
the cylindrically shaped neck is formed from the bridge portion in the first direction or is formed from the bridge portion in a third direction, opposite the first direction;
the material includes one only single piece of low carbon steel;
the first and second surfaces are parallel to the longitudinal axis;
the first and second holes are aligned in the second direction; and,
the longitudinal axis passes through the threaded opening and the space.

2. The clevis of claim 1, wherein the material includes a corrosion-resistant metallic coating covering the one only single piece of low carbon steel.

3. The clevis of claim 1, wherein the low carbon steel has a carbon content of less than 0.15 percent.

4. The clevis of claim 1, further comprising:
a third hole passing through the first side wall; and,
a fourth hole passing through the second side wall and aligned with the third hole in the second direction.

5. The clevis of claim 4, wherein:
the first and second holes are aligned in the second direction; and,
the third and fourth holes are aligned in the second direction.

6. The clevis of claim 1 wherein:
the first and second side walls have a respective first thickness, in the second direction;
the neck has a second thickness in the second direction; and,
the second thickness is about ¾ of the first thickness.

7. A method of stamping a clevis for an air brake assembly, comprising:
stamping a sheet of steel to form a planar blank comprising:
a first longitudinal axis passing through first and second longitudinal ends;
first and second oppositely facing planar surfaces;
a central portion with a uniform width orthogonal to the first longitudinal axis;
a first end portion extending from the central portion along the first longitudinal axis in a first direction and tapering toward the first longitudinal end; and,
a second end portion extending from the central portion along the first longitudinal axis in a second direction, opposite the first direction, and tapering toward the second longitudinal end;
piercing the blank to form:
a first hole between a center point of the first longitudinal axis and the first longitudinal end and connecting the first and second surfaces; and,
a second hole between the center point of the first longitudinal axis and the second longitudinal end and connecting the first and second surfaces;
forming the blank to form a ring-shaped neck:
including a third hole; and,
extending from the central portion and the second planar surface in a third direction parallel to a second longitudinal axis passing through the third hole;
bending a first portion of the blank, including the first longitudinal end, along a first line orthogonal to the first longitudinal axis, passing through the central portion, and between the first hole and the third hole such that the first portion of the blank is parallel to the second longitudinal axis and extends from the central portion in a fourth direction, opposite the third direction;
bending a second portion of the blank, including the second longitudinal end, along a second line orthogonal to the first longitudinal axis, passing through the central portion, and between the second hole and the third hole such that the second portion of the blank is parallel to the second longitudinal axis and respective segments of the first surface included in the first and second portions of the blank face each other; and,
threading an inner circumferential surface of the third hole.

8. The method of claim 7, further comprising punching a hole centered on the second longitudinal axis prior to forming the ring-shaped neck.

9. The method of claim 7, wherein bending the blank includes positioning the respective segments of the first or second surface to be equidistant from the second longitudinal axis.

10. The method of claim 9, wherein positioning the respective segments of the first or second surface includes positioning the respective segments parallel to each other.

11. The method of claim 7, further comprising:
enlarging the first and second holes such that the first and second holes are aligned in a fifth direction orthogonal to the second longitudinal axis.

12. The method of claim 7, further comprising:
piercing the blank to form:
a fourth hole, between the first hole and the first longitudinal end, and connecting the first and second surfaces; and,
a fifth hole, between the second hole and the second longitudinal end, and connecting the first and second surfaces.

13. The method of claim 12, wherein:
the first and second holes are aligned in a fifth direction orthogonal to the second longitudinal axis; and,
the fourth and fifth holes are aligned in the fifth direction.

14. The method of claim 7, further comprising:
applying a corrosion-resistant metallic coating.

15. A method of stamping a clevis for an air brake assembly, comprising:
stamping a sheet of steel to form a planar blank comprising:
a first longitudinal axis passing through first and second longitudinal ends;
first and second oppositely facing planar surfaces;
a central portion with a uniform width orthogonal to the first longitudinal axis;
a first end portion extending from the central portion along the first longitudinal axis in a first direction and tapering toward the first longitudinal end; and,
a second end portion extending from the central portion along the first longitudinal axis in a second direction, opposite the first direction, and tapering toward the second longitudinal end;
piercing the blank to form:
a first hole between a center point of the first longitudinal axis and the first longitudinal end and connecting the first and second surfaces; and,
a second hole between the center point of the first longitudinal axis and the second longitudinal end and connecting the first and second surfaces;
forming the blank to form a ring-shaped neck:
including a third hole; and,
extending from the central portion and the first planar surface in a third direction parallel to a second longitudinal axis passing through the third hole;
bending a first portion of the blank, including the first longitudinal end, along a first line orthogonal to the first longitudinal axis, passing through the central portion, and between the first hole and the third hole such that the first portion of the blank is parallel to the second longitudinal axis and extends from the central portion in the third direction;
bending a second portion of the blank, including the second longitudinal end, along a second line orthogonal to the first longitudinal axis, passing through the central portion, and between the second hole and the third hole such that the second portion of the blank is parallel to the second longitudinal axis and respective segments of the first surface included in the first and second portions of the blank face each other; and,
threading an inner circumferential surface of the third hole.

16. The method of claim 15, further comprising punching a hole centered on the second longitudinal axis prior to forming the ring-shaped neck.

17. The method of claim 15, wherein bending the blank includes positioning the respective segments of the first or second surface to be equidistant from the second longitudinal axis.

18. The method of claim 17, wherein positioning the respective segments of the first or second surface includes positioning the respective segments parallel to each other.

19. The method of claim 15, further comprising:
enlarging from the first and second holes such that the first and second holes are aligned in a fourth direction orthogonal to the second longitudinal axis.

20. The method of claim 13, further comprising:
piercing the blank to form:
a fourth hole, between the first hole and the first longitudinal end, and connecting the first and second surfaces; and,
a fifth hole, between the second hole and the second longitudinal end, and connecting the first and second surfaces.

21. The method of claim 18, wherein:
the first and second holes are aligned in a fourth direction orthogonal to the second longitudinal axis; and,
the fourth and fifth holes are aligned in the fourth direction.

22. The method of claim 13, further comprising:
applying a corrosion-resistant metallic coating.
